(19) United States
(12) Patent Application Publication
(10) Pub. No.: US 2010/0125476 A1
(43) Pub. Date: May 20, 2010

(54) SYSTEM HAVING BUSINESS AWARE FRAMEWORK FOR SUPPORTING SITUATION AWARENESS

(76) Inventors: Keun-Hyuk Yeom, Yeonje-gu (KR); Sung-Jin Park, Dong-gu (KR); Min-Woo Hong, Buk-gu (KR); Han-Jun Kim, Gangseo-gu (KR); Tae-Woo Nam, Yeonje-gu (KR)

Correspondence Address: SHERR & VAUGHN, PLLC, 620 HERNDON PARKWAY, SUITE 320, HERNDON, VA, 20170, US

(21) Appl. No.: 12/566,355

(22) Filed: Sep. 24, 2009

(30) Foreign Application Priority Data
Nov. 20, 2008 (KR) 10-2008-0115726
Feb. 25, 2009 (KR) 10-2009-0015863

(51) Int. Cl. G06Q 10/00; G06F 17/30

(52) U.S. Cl. 705/7; 707/E17.005; 707/E17.014; 707/E17.044; 705/348

(57) ABSTRACT

The present invention relates to a system having a business aware framework for supporting situation awareness, which provides an RFID business event modeling system having a modeling function that allows a developer to easily define RFID business events required in developing RFID applications in conformance to EPC network standards so that the user can specify the steps of acquiring and processing data using the RFID technology and define whether to infer a situation, thereby conveniently using the invention for applications based on EPC and sensor data.

### BACKGROUND OF THE INVENTION

1. Field of the Invention

The present invention relates to a system having a business aware framework for supporting situation awareness, which provides an RFID business event modeling system having a modeling function that allows a developer to easily define RFID business events required in developing RFID applications in conformance to EPC network standards so that the user can specify the steps of acquiring and processing data using RFID technology and define whether to infer a situation, thereby conveniently using the invention for applications based on EPC and sensor data.

2. Background of the Related Art

Radio Frequency Identification (RFID) technology is a technology capable of recognizing information on an object using tags responding to radio signals.

The RFID technology can sense information even without coming into direct contact with an object and can sense information by penetrating through obstacles. In addition, information on a plurality of objects can be recognized at a time, and a large quantity of information stored in a memory can be recognized. Therefore, the RFID technology is scheduled to be introduced in a variety of business areas such as logistics management, distribution management, and the like, and various kinds of application systems supporting the RFID technology need to be constructed.

Currently, standardization of RFID-related technology is in progress by EPCglobal.

The EPCglobal proposes an international standard called EPCgobal network (i.e., EPC network). Like the concept of the Internet, respective local EPC networks gather to build the global EPC network, which makes it possible to grasp any item with it attached with an EPC no matter when, where, and which business it has been connected with.

The EPC network proposes the EPC architecture capable of collecting the electronic product code (EPC), which is unique object information, and acquiring related information while removing redundancy of the EPC.

The EPC network architecture includes an EPC tag, an RFID reader, RFID middleware, an EPC information service (EPCIS), an EPCIS discovery service (EPCIS DS), and an object naming service (ONS).

An RFID business event represents information acquired from a variety of constitutional components in the EPC network in order to construct an application system required in abruptly changing business environments by adopting the RFID technology and information on RFID events processed to be suitable for business rules of a desired type, which is expressed in an XML format.

A business event specification (BESpec) refers to an XML-based specification which supports the EPCglobal architecture, supports development and management of an RFID system, and expresses the steps of acquiring and processing data in the RFID business event framework.

Since a developer has a lot of difficulties in expressing RFID business events by directly defining expressions of a business in an XML format in conformance to the EPC network standards.

Therefore, there is a need to develop a support tool for allowing a developer to easily create RFID business event specifications and EPC network standard specifications in conformance to the standards.

Moreover, such an EPC related technology, i.e., an RFID technology makes it possible to identify an object, but makes it difficult to grasp a state of the object. In a real industrial process of logistics and distribution, works are frequently performed through sensor information, such as information on the current temperature of an object, information on the storing state of an object, and the like, rather than information on the type of the object. In view of this fact, studies on integrating a conventional RFID technology with sensor networks are in progress.

The RFID and sensor technology is an acquisition process of the lowest level, i.e., collection of information.

At this point, it is more important to grasp a current state and how to cope with the current situation than to receive a given value a sensor from the view point of a user. A situation awareness technology is studied as a technology for providing such active information, and studies on a variety of fields, such as an ontology technology for expressing situation awareness, a situation modeling technology, a situation awareness service providing technology, and the like, are in progress.

If a part serving to perform an interaction with constitutional components of the EPC network architecture is combined with a pure business logic that has nothing to do with the RFID technology in developing an application system, complexity is increased since even a part deeply related to technical processing of the RFID should be taken into consideration when business logic to be processed by an application system needs to be updated in abruptly changing business environments, which makes it difficult to perform maintenance and repair.

In the case of a situation awareness middleware field, a developer suffers from a difficulty in accessing an actual code level and specifically describing functions to be used in certain situations. That is, although a support tool is proposed in the form of a middleware, it is general that the support tool is actually proposed in the form of a development skeleton.

In some other situation awareness technique fields proposed in the form of middleware, since the steps of collecting and processing sensor data are not mentioned or mentioned without considering the REID technology, it is uncertain that whether the technology can be put into practice.

In a system that does not support situation awareness, an additional cost is required if an unexpected situation occurs, and thus a loss in business may be made in the end.

Therefore, in order to solve the above problems, there is a need for development of a system having a business aware framework for supporting situation awareness so that the system can be usefully used in an application based on EPC and sensor data.

### SUMMARY OF THE INVENTION

Accordingly, the present invention has been made in view of the above problems, and it is an object of the present invention to provide an RFID business event modeling system having a modeling function that allows a developer to easily define RFID business events required in developing RFID applications in conformance to EPC network standards.

The present invention has been made in an effort solve problems of the RFID technology and the application technology thereof, and another object of the present invention is to provide a system having a business aware framework for supporting situation awareness, which allows a user to specify the steps of acquiring and processing data and define whether to infer a situation, so that the system can be usefully used in applications based on EPC and sensor data.

Yet another object of the present invention is to provide a base environment, such as a communication technology or a communication module, required in developing applications based on RFID and sensor data.

### BRIEF DESCRIPTION OF THE DRAWINGS

FIG. 1 is a block diagram showing the configuration of a business event specification.

FIGS. 2a and 2b are views showing an example of a QuerySpec referenced by the business event specification.

FIG. 3 is a view showing an example of a business event specification.

FIG. 4 is a view showing the configuration of an RFID business event modeling system according to the present invention.

FIGS. 5a and 5b are flowcharts illustrating an RFID business event modeling operation according to an embodiment of the present invention.

FIG. 6 is a block diagram showing the configuration of a business aware framework for supporting situation awareness according to the present invention.

FIGS. 7a to 7g are block diagrams showing the configuration of internal modules of the business aware framework for supporting situation awareness.

FIG. 8 is a flowchart illustrating a detailed operation of the inference module.

### DETAILED DESCRIPTION OF THE PREFERRED EMBODIMENT

Now, the preferred embodiments of a business event modeling system and a system having a business aware framework for supporting situation awareness according to the invention will be described hereafter in detail with reference to the accompanying drawings.

The features and advantages of the business event modeling system and the system having a business aware framework for supporting situation awareness according to the invention will be apparent from the detailed descriptions of the embodiments which will be described below.

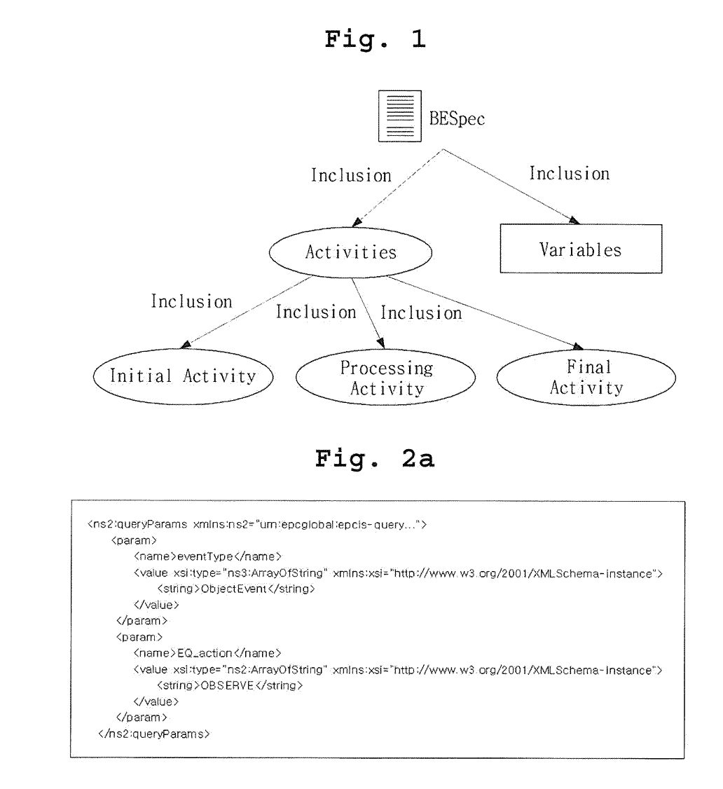

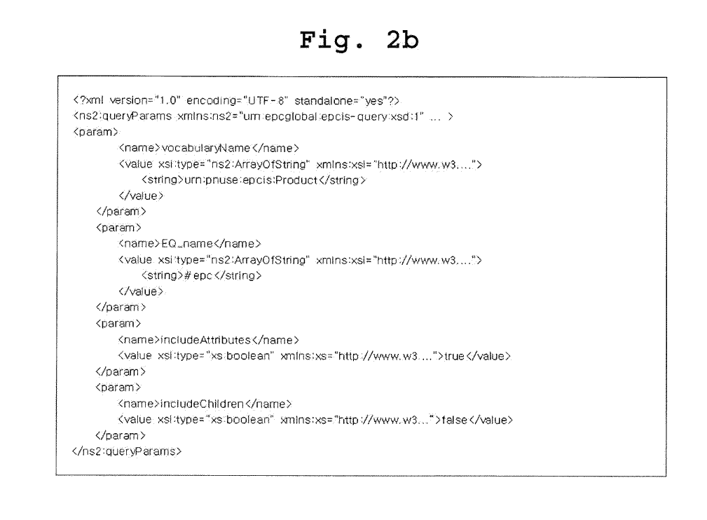

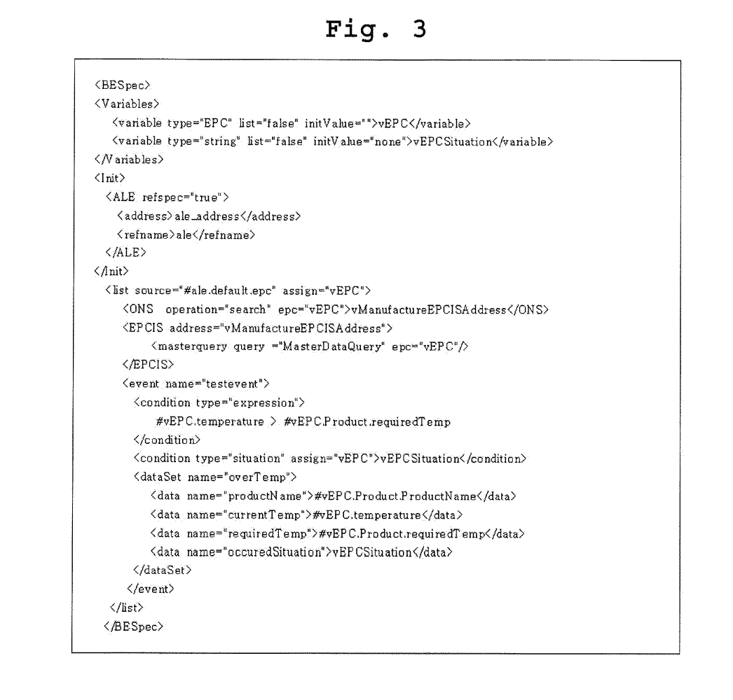

FIG. 1 is a block diagram showing the configuration of a business event specification, and FIGS. 2a and 2b are views showing an example of a QuerySpec referenced by the business event specification.

FIG. 3 is a view showing the configuration of an RFID business event modeling system according to the present invention.

The present invention relates to a radio frequency identification (RFID) technique and middleware for supporting software development that requires situation information based on sensor data, such as temperature, humidity, and the like.

The present invention enables development of application systems based on RFID and sensor data, and includes a business aware framework (BizAF4SA) for supporting situation awareness, which is a framework that supports to use predefined awareness information and includes a business event specification (BESpec) defining the steps of collecting and processing information and a situation inference module.

The present invention includes an RFID business event modeling tool for automatically generating a variety of specifications needed for developing RFID applications through a process of modeling RFID business events and verifying information using the modeled information, and the RFID business event modeling tool implements a function of loading the variety of specifications.

The BESpec is created by an application system developer and defines the types of information, the sources to acquire the information, the process of converting the information, and whether to inquire real-time situation information.

The BESpec is largely divided into a variable declaration part and an activity part defining various types of processing steps as shown in FIG. 1.

The activity is subdivided into an initial activity for processing the step of acquiring information, a processing activity for acquiring additional information and performing comparisons and operations, and a final activity for defining the types of values resulting from conditional statements and comparison of defined situations.

The variable declaration part is used for storing processed values in the middle of processing an activity. A result processed in an activity can be used in another activity through the variables.

The activity part defines activities for processing and converting the values of EPC and sensor data collected in real-time, and each activity may have different attribute values that need to be internally described.

The system having a business aware framework for supporting situation awareness according to the invention is based on an EPC network presented by EPCglobal and collects EPC and sensor information from sensor tags.

TABLE 1

| Activities | | Descriptions | Remarks |
|---|---|---|---|
| Initial | ALE | Collect real-time ALE | Refer to |
| | | events from ALE middleware | ECSpec |
| | EPCIS | Collect stored EPCIS events | Refer to |
| | | from EPCIS | QuerySpec |
| Processing | ONS | Search for the address of | |
| | | EPCIS containing unique | |
| | | information corresponding | |
| | | to EPC, by querying ONS | |
| | EPCISDS | Search for an address list | |
| | | of EPCIS containing | |
| | | tracking information, | |
| | | corresponding to EPC, by | |
| | | querying EPCIS DS | |
| | EPCIS | Search for unique | Refer to |
| | | information corresponding | QuerySpec |
| | | to EPC and tracking | |
| | | information, by querying | |
| | | EPCIS | |
| | List | Perform iterative | |
| | | operations on a plurality | |
| | | of data types | |
| | Compute | Perform operations on | |
| | | variables and add and | |
| | | delete items of the EPC | |
| | | list | |
| Final | Event | Create data transmission | |
| | | type and a report according | |
| | | to conditions of generating | |
| | | events | |
| | Condition | Define conditions based on | |
| | | variable comparisons and | |
| | | situation inference, and | |
| | | provide the conditions in a | |
| | | String or Boolean type | |

The initial activity collects EPC and sensor data from ALE middleware and EPCIS events stored in real-time from the EPCIS.

At this point, an ECSpec needs to be created for communication with ALE. The ECSpec is a standard document defined by EPCglobal and defines conditions on collecting and filtering the data.

A QuerySpec needs to be created for communication with EPCIS. The QuerySpec is defined by converting QueryInterface defined by EPCglobal into XML, and names of real interfaces are expressed in an XML document.

The ECSpec is a specification defining interactions with the ALE middleware. The ECSpec is used by Reading APIs of EPCglobal ALE 1.1 Specification and includes information on definition of information types when real-time information is acquired from the ALE middleware within the BESpec.

If the ECSpec is defined, the ALE middleware is notified with ECReport including corresponding EPC information. Since the ECSpec is presented by the EPCglobal, its examples and usage will not be described.

The QuerySpec is a specification for querying tracking information (event data) or unique information (master data) related to the EPC stored in the EPCIS. The QuerySpec should comply with query interfaces of the EPCIS in order to query data related to the EPC.

The query interfaces provide a variety of functions, and the functions should define “QueryParam” in common. The functions require to provide a set of query name and parameter.

There are various functions in the query interfaces, and “subscribe” function is used in the initial activity. The eventquery of the processing activity uses a function of “poll.” The difference between the functions depends on synchronization and non-synchronization.

“Subscribe” is a non-synchronous method and collects data recorded in real-time whenever the data is generated. “Poll” is a function for collecting data only when a synchronous query is issued.

FIG. 2a shows an example of QuerySpec when the “subscribe” function is performed. The meaning of the contents is to collect results of “OBSERVE” operation performed on “ObjectEvent”, i.e., a single object, among the stored data.

If a query is issued on the EPCIS using the above contents, result data is returned at predetermined intervals whenever data is stored. The interval can be set when a subscribe query is issued. Since the contents are also presented in the EPCglobal standard documents, they will not be described in the present invention.

The QuerySpec can be used in the processing activity, as well as in the initial activity. Additional information on the EPC collected through the ALE middleware can be requested. At this point, since the repository of the additional information is the EPCIS, acquisition of additional information can be defined for the convenience of a user.

FIG. 2a shows an example of QuerySpec used for an EPCIS query in a real processing activity.

Information like a “#epc” value is provided within the category of “urn:pnuse:epics:Product”. Here, “#epc” is an internal keyword for being used to consider the EPC collected from the ALE.

The processing activity defines the steps of acquiring and processing additional information. The processing activity includes EPCIS, EPCIS DS, ONS, Compute and list activities. Among these, the EPCIS, EPCIS DS, and ONS activities are activities for acquiring additional information related to the EPC.

Although the structure actually presented by the EPCglobal can be the contents used in a single enterprise or company, it is a structure that can be used in a global form in association with a general distribution process.

Accordingly, there needs a method of searching and inquiring information among EPCISs operating in a variety of ways respectively. The structures presented for this purpose are ONS and EPCIS DS. The structure of the ONS and EPCIS DS is currently under the process of standardization by the EPCglobal, and companies currently developing the structure employ only the concept and implement the structure in their own way.

It can be regarded that the ONS searches for EPCIS having unique information of a real product and the EPCIS DS searches for a set of EPCISs having tracking information of a product. That is, the ONS activity performs a process of acquiring information in association with an ONS system, the EPCIS DS activity performs a process of acquiring information in association with an EPCIS DS system, and the EPCIS activity performs a process of acquiring information in association with an EPCIS system.

The Compute activity is an activity for supporting four arithmetic operations or logical operations. The Compute activity can determine the total number of collected EPCs or store the number of currently collected EPCs.

The List activity is an activity for supporting iterative operations, which is used in the case where iterative operations are required since it does not guarantee that only single data is collected when real-time data are collected from the ALE and the EPCIS. A variety of activities can be reused within the List activity.

Finally, the final activity is an activity for defining conditions for creating a result of a process flow or a type of a result.

Schematically, the final activity includes a Condition activity and an Event activity.

The Condition activity supports two types of methods, i.e., a method of determining whether to perform an operation by comparing variables that store the results of previously performed operations and a method of determining whether to perform an operation by a situation value inferred based on real-time EPC and sensor data.

The Event activity expresses the data type of a result, which generates a form for transferring the values generated by the defined keywords and the values stored in the variables to a user.

FIG. 3 is a view showing an example of a BESpec.

Current information on a product stored in a cold storage is obtained, and a product name, current temperature according to the product, storage temperature required by the product, and current state of the product are expressed.

At this point, “#” placed in front of a variable name means that a value of a specific keyword corresponding to the variable is searched for. The notation of #(variable name) means that a “.” notation should be used in order to use a specific keyword value related to a corresponding variable value.

In FIG. 3, #vEPC.temperature expresses that a temperature sensor value according to the EPC value stored in the variable vEPC is used.

The value can be used in a different manner depending on a value used by a sensor tag. In the present invention, four types of sensor values such as temperature, humidity, illumination, and shock are used.

Then, “#vEPC.Product.requireTemp” means that unique information of a product is inquired from the EPCIS DS using a unique information value defined in a corresponding EPC and the EPCIS DS uses the stored value. It means that, among the results of the inquiry of the EPC corresponding to “vEPC”, the category is “Product”, and the attribute is “requireTemp”. Since the elements that can be defined as unique information are indefinite by a developer in a real EPCIS, it is necessary to understand and use actually stored elements.

The BESpec is used when a system of a business aware framework (BizAF4SA) is actually driven, and a processing procedure and an operating module are determined depending on the contents of a created specification.

Hereinafter, an RFID business event modeling tool according to an embodiment of the present invention will be described.

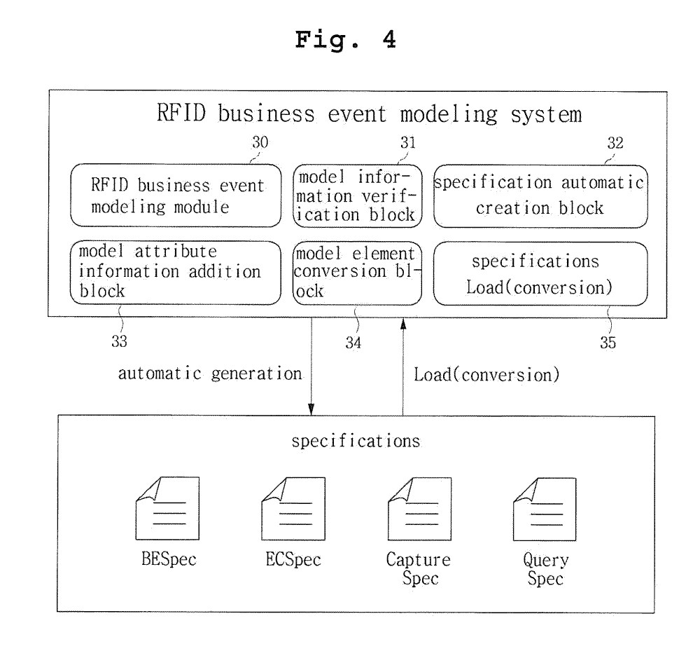

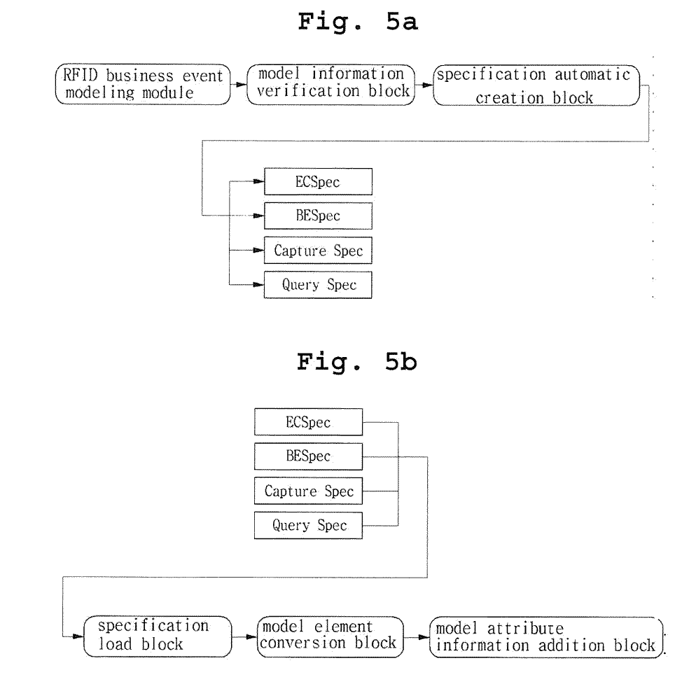

FIG. 4 is a view showing the configuration of an REID business event modeling system according to the present invention. FIGS. 5a and 5b are flowcharts illustrating an RFID business event modeling operation according to an embodiment of the present invention.

The present invention automatically generates a variety of specifications needed for developing RFID applications, through a process of modeling RFID business events and verifying information based on the modeled information, and implements a function of loading the variety of specifications.

As shown in FIG. 4, the RFID business event modeling system according to the present invention comprises an RFID business event modeling block 30, a model information verification block 31, a specification automatic generation block 32, a specification load block 35, a model element conversion block 34, and a model attribute information addition block 33.

The RFID business event modeling block 30 provides a GUI screen so that a user may input attribute information needed for each model element as a process of the RFID business event modeling.

That is, the RFID business event modeling block 30 shows an interface of RFID business events including a BESpec, EPCIS capture specification (Capture Spec) referred by the BESpec, EPCIS query specification (Query Spec), and event cycle specification (ECSpec) in the form of GUI and expresses a flow of the RFID business events.

The model information verification block 31 verifies whether standard specifications presented by the BESpec and EPC network can be generated from the information needed for the specifications before the specifications are automatically generated based on the information modeled by the user in the RFID business event modeling block 30.

The specification automatic generation block 32 automatically generates an EPCIS capture specification (Capture Spec), EPCIS query specification (Query Spec), and event cycle specification (ECSpec) based on the information modeled by the user in the RFID business event modeling block 30 and the conversion file in conformance to the standards presented by the BESpec and EPC network and stores a preview function and the generated specifications.

In addition, the specification automatic generation block 32 may rapidly generate the automatically generated documents using a conversion file defining conversion rules.

The specification load block 35 loads the specifications automatically generated by the RFID business event modeling block 30 and specifications previously created by the user using other tools, analyzes information specified in the corresponding specifications, verifies whether the corresponding specifications can be expressed as modeling elements, and stores the information.

The model element conversion block 34 converts the information of the specifications analyzed by the specification load block 35 into model elements and expresses the model elements.

The model attribute information addition block 33 adds up attribute information needed for a corresponding model element based on the information acquired from the specification load block 35.

The operation process among the constitutional blocks of the RFID business event modeling system according to the present invention can be divided into an RFID business event specification generation function and a specification load function.

FIG. 5a shows the processing steps of the RFID business event specification generation function, which shows the process of automatically generating a variety of specifications through the RFID business event modeling block, model information verification block, and specification automatic generation block in sequence.

FIG. 5b shows the processing steps of the specification load function, which shows the process of acquiring information from the specification load block, adding model elements through the model element addition block, and adding information needed for respective model elements.

Hereinafter, a system having a business aware framework for supporting situation awareness according to another embodiment of the invention will be described in detail.

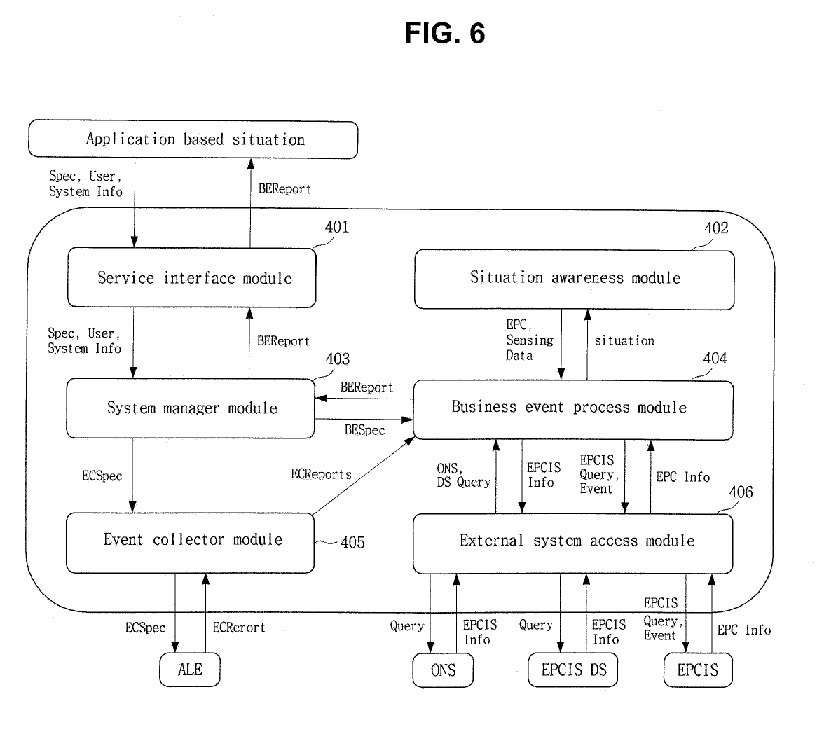

FIG. 6 is a block diagram showing the configuration of a business aware framework (BizAF4SA) for supporting situation awareness according to the present invention.

The business aware framework for supporting situation awareness according to the present invention comprises an event collector (EventCollector) module 405 for communicating with ALE and collecting information on EPC and sensor data in order to generate business events, a service interface (SericeInterface) module 401 for requesting and transmitting information between the business aware framework for supporting situation awareness and a middleware user, an external system access (ExternalSystemAccessor) module 406 for communicating with the EPCIS DS, a business event processor (BusinessEventProcessor) module 404 for analyzing business event specifications and generating business events, a system manager (SystemManager) module 403 for managing the entire services, reference specifications, and setting information of the business aware framework for supporting situation awareness, and a situation awareness (SituationReasoner) module 402 for inferring a current situation using currently collected EPC and sensor data when the business event specification analyzed by the business event process (BusinessEventProcessor) module 404 contains a situation comparison statement.

The detailed configuration of each module of the system having a business aware framework for supporting situation awareness is described below.

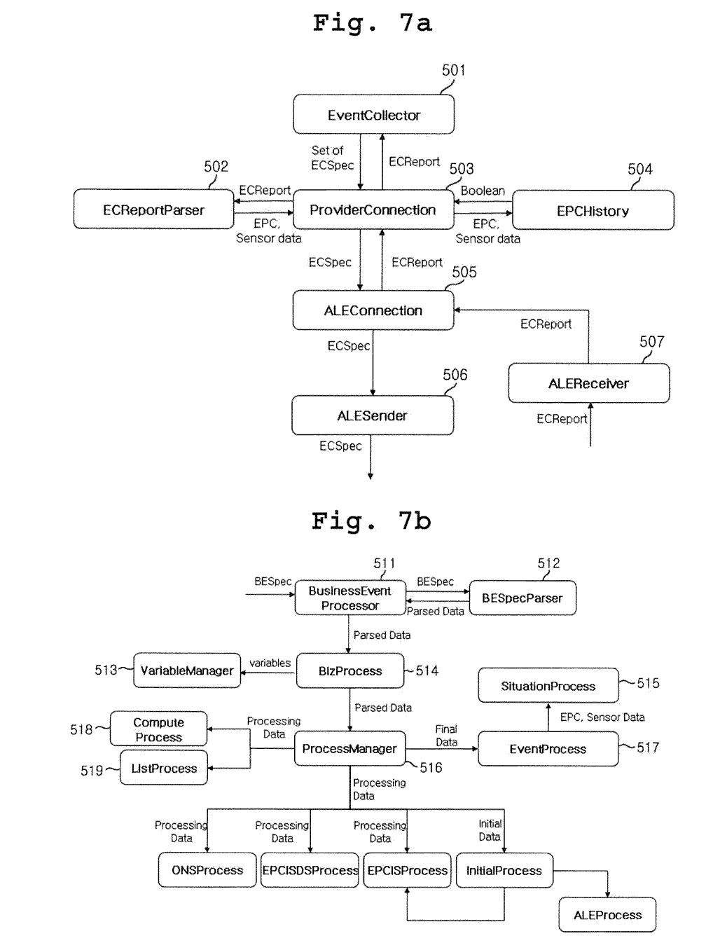

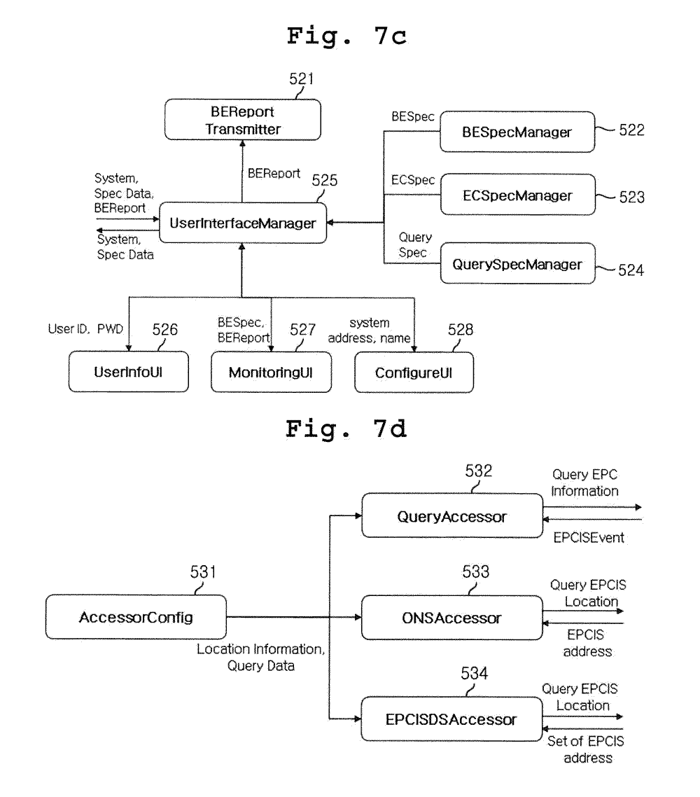

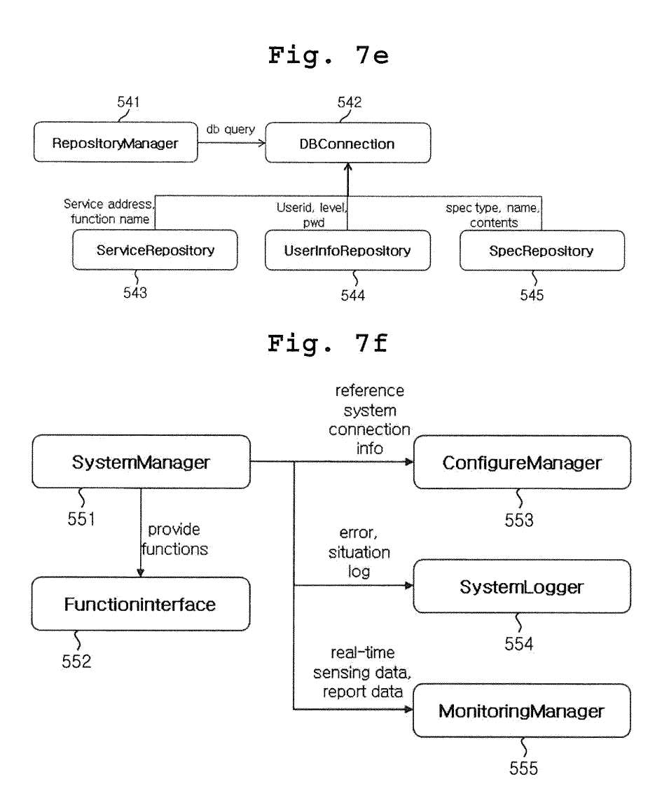

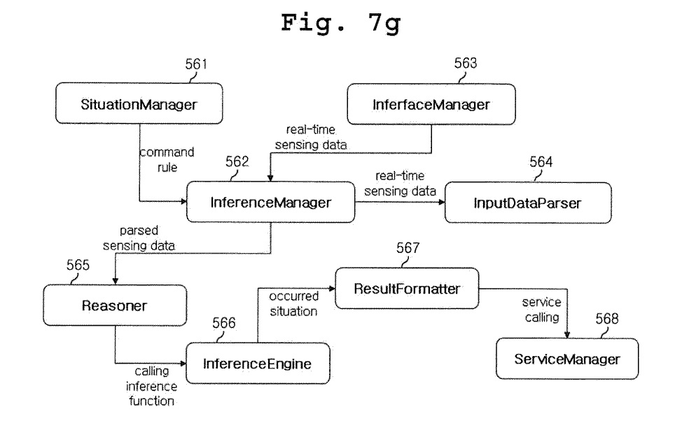

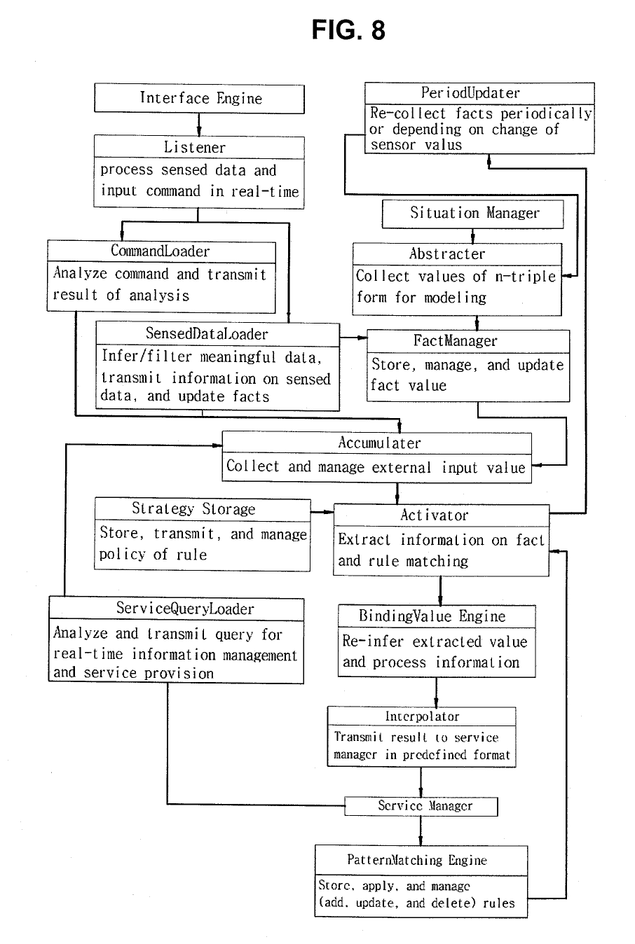

FIGS. 7a to 7g are block diagrams showing the configuration of internal modules of the business aware framework for supporting situation awareness, and FIG. 8 is a flowchart illustrating a detailed operation of the inference module.

First, the event collector (EventCollector) module 405 interfaces the business aware framework (BizAF4SA) with ALE middleware and collects real-time ALE events from the ALE middleware through the ALEConnection 505, ALESender 506, and ALEReceiver 507 as shown in FIG. 7a.

Then, unique information of the EPC is stored in a temporary repository. Corresponding information is stored through the EPCHistory 504 class, and whether a corresponding EPC has been generated before is searched for.

There is an interface of “subscribe” in the ALE middleware, and ECReport is transmitted in the TCP method. That is, it is possible to call a web service and acquire a result through the “ALESender” class if the “subscribe” method is not used. However, a result value should be acquired using the “ALEReceiver” class in the case of the “subscribe” method.

The business event process (BusinessEventProcessor) module 404 analyzes a result by driving neighboring modules depending on the contents of actually registered BESpec.

As shown in 7b, the business event process module includes variables and an activity analysis class defined in the internal BESpec and uses ECSpec, ECReport, QuerySpec and EPCIS Event types as reference data types.

All the processes performing an activity are accessed in a polymorphism method using an abstract class of BizProcess 514. This is a structure for easily taking into account a case where an additional activity is created, considering scalability in the future.

The BESpecParser 512 analyzes and processes BESpec internally using SAX parser in the present invention, and other parsers such as DOM, JAXB, and the like can be used.

As shown in FIG. 7c, the service interface (ServiceInterface) module 401 comprises a BEReport Transmitter 521, a user interface manager 525, a BESpecManager 522, an ECSpecManager 523, and a QuerySpecManager 524, in addition to user interface blocks of a UserinfoUI 526, a MonitoringUI 527, and a ConfigureUI 528.

The service interface (ServiceInterface) module 401 provides an interface between a user and the business aware framework (BizAF4SA) for the cases of registering and deleting BESpec, commencing and suspending a business service, and the like.

In addition, the service interface module also performs a function of returning the BEReport generated as a result of processing the BESpec to a user or an application system, in the form of a web service.

The external system access module 406 communicates with systems, other than the ALE middleware, configuring an EPC network. As shown in FIG. 7d, an individual connection class is created in each of the ONS, EPCIS, and EPCIS DS, and a plurality of BESpecs accesses and uses the created classes.

After the event collector (EventCollector) module 405 acquires EPC, reference information corresponding to the EPC is obtained through the EPCISAccessor class of the external system access module 406. Since each of the external systems provides a web service interface, real communication is accomplished through the Stub class of a corresponding service.

The repository manager (RepositoryManager) module stores various kinds of specification information, including user information, service information, and BESpec used by the business aware framework.

FIG. 7e is a view showing the configuration of the repository manager (RepositoryManager) module.

A variety of information is stored in the database through the DBConnection class 542, and desired information is acquired using lower classes of SpecRepository 545, ServiceRepository 543, and UserRepository 544.

The system manager (SystemManager) module 403 manages the overall system of the business aware framework (BizAF4SA).

As shown in FIG. 7f, the system manager module performs basic functions such as managing physical information of the system, physical information of external systems, states of various specifications, and user accounts, monitoring currently provided services, and logging events generated from the system.

The situation awareness (SituationReasoner) module 402 performs context conversion and inference related to the situation awareness function.

As shown in FIG. 7g, the situation awareness module acquires rule information that is to be compared from the situation manager (SituationManager) 561 and real-time collection data through the interface manager (InterfaceManager) 563.

The inference engine is called through the interface manager (InterfaceManager) 563, and the situation awareness module extracts current situation through the inference engine.

A JESS engine is used as an inference engine in the embodiment of the invention. A variety of engines such as JENA, RACER, and the like can be used as the engine.

The result formatter (ResultFormatter) 567 determines an XML format of the inferred result, and the service manager (ServiceManager) 568 performs an actual service or transmits a result value.

FIG. 8 is a flowchart illustrating the operation of the internal inference module of the situation awareness (SituationReasoner) module 402.

The internal inference process of the situation awareness (SituationReasoner) module 402 comprises the steps of processing sensed data and command in real-time through the interface engine, collecting and processing fact values through the situation awareness manager (SituationManager), extracting information based on facts and rule matching, and analyzing and providing real time information.

First, the step of processing sensed data and command in real-time includes the steps of processing the sensed data and command in real-time, analyzing the command and transmitting a result of the analysis, and transmitting information on the sensed data and updating the facts after inferring and filtering meaningful data.

The step of collecting and processing fact values includes the steps of re-collecting facts periodically or depending on a change of sensor values, collecting values of an N-triple form for modeling, and storing, managing, and updating the fact values.

The step of extracting information based on facts and rule matching includes the steps of collecting and managing external input values, storing and managing policy of rules and extracting information based on the facts and rule matching, re-inferring the extracted values and processing information, organizing and managing result values, transmitting the information to a service manager in a predefined format, and analyzing and transmitting a query for real-time information management and service provision.

Hereinafter, the internal inference step of the situation awareness (SituationReasoner) module 402 will be described in further detail.

The situation awareness (SituationReasoner) module 402 has a part for receiving information from a variety of inputs, and the information can be categorized based on characteristics of the input and characteristics of inference tendency of the information.

The situation awareness module has functions and rules for inferring services and queries implemented to inquire information from the facts.

The situation awareness module converts the information into facts based on the ontology model, stores the facts, and collect and extracts needed information through a query. Before implementing the situation awareness module based on the query, a storage space for storing information on the ontology in the form of N-triple of subject, predicate, and object is secured using a JESS terminology ‘deftemplate’ through ‘naming’.

It is possible to systematically manage the information by storing the facts loaded on the secured space, and basic environments and user information, as well as relationships among the facts, are stored when the facts are stored.

In addition, a form for extracting information stored in the facts in the form of ‘defquery’, i.e., information needed by ‘context’, is specified.

It is extracting a variable other than the variables of subject, predicate, and object within the space secured by naming on the basis of one or more of the variables. A template having different naming is considered to be in a different space, and thus another form of query is needed. A query extracts a detailed value from the facts. Furthermore, all sorts of queries, e.g., for searching for all of the values of the template or searching for a name, can be implemented based on the name of the space.

Although a query is basically constructed as a basic framework for extracting information, it is applied to searching for specific information in order to infer a service or situation awareness. In order to apply a rule, there is a rule for applying the rule and a rule needed for setting a priority or applying method. It is a form of defining a rule through a command of ‘defrule’.

Among these, there are some rules implementing a system operation corresponding to an input depending on a state. The inference engine waits for information or a command inputted from Java in a sleep or listening state. If an input is issued, the inference engine transits to a wakeup state. Then, the input value is analyzed and transmitted to a state part described below depending on the input type.

‘command’ is a part for implementing an operation of a specific device or a statically patterned service depending on a user's command.

‘sensed data’ is data inputted according to a change of external environments, which is a part for implementing an operation of an additional service caused by the change of the external environments or an operation for dynamically monitoring a change in the external environments

‘query’ is a part for processing information created and inputted through an external query API when a user requests to search for a location, a device state, or environment information.

An actual inference is accomplished using the rules by processing values of information collected from the facts through a query. Unlike a processing rule for implementing a service, it is almost similar to expanding a function type and a query.

Since the inference is accomplished by comparing and analyzing a specific input and stored information, only a primary static type inference is enabled. Most of existing inference engines adopts such a type. The inference engine issues a command to search for values of information and facts loaded from the ontology based on the inputted information, and if the same value is found from the facts, a variety of values is outputted depending on the relationship among the values.

That is, if one or more pieces of information among the N-triple (subject, predicate, and object) values are inputted, information is searched for depending on the relationship based on a query for searching for other values. Relationship inference is based on the policies determined by system rules.

There are two types of inferences. One is a type of setting an IP depending on an input state, and the other is a type of searching for a sensor value when a space and a property value are inputted. It is a method of implementing an inference by iteratively searching for a value from the facts on the basis of a query in the first place and then creating and outputting a result value using the rules.

Such a rule acts as a basis for all service rules and is linked as a basis of the other rules like a function. It is configured such that some of the rules utilized for all the service rules are converted into a function so as to be utilized by all of the rules through a call.

An element having a form of a function and another element having a form of a rule are compositely applied as a rule existing for implementing an actual service, and thus a needed service is inferred from facts and input values.

In a service of a certain pattern, functions are defined as generalized rules for the sake of iterative verification of inference or efficiency of work done by a query for a fact, which is generally utilized for a service of a static patterned state.

The two types of rules are used for implementing a service, which are rules for storing and managing information on a countermeasure or service when an ACK/NACK, i.e., a response to a command for the inferred service, is received from the service manager.

As a service rule for a response to a user command, a static pattern service operates depending on a specific command or sensor value. If the service pattern is dynamic, a basic service appropriate to the situation is inferred. The inference engine infers a service on receiving an input value, and if a collision is detected with respect to the service, the inference engine searches for a situation and a priority and makes an inference based on a space or specific situation.

A service is determined through a series of operations described above, and information on the implementation of the service stored in the facts is compared and analyzed in order to examine the collision on the service.

As described above, the RFID business event modeling system according to the present invention allows a user to easily understand the information expressed in the RFID business events and correctly create specifications since the user uses a business event modeling tool instead of creating a business event specification and the specifications presented by the EPC network.

The system having a business aware framework for supporting situation awareness according to the present invention allows a user to specify the steps of acquiring and processing data and define whether to infer a situation and thus can be conveniently used in an application based on EPC and sensor data.

Besides, the present invention may provide a base environment, such as a communication technology or a communication module, required in developing applications based on the RFID and sensor data.

Furthermore, the present invention provides a middleware for supporting rapid development and management of a system, and thus automation of a process is enabled through a situation awareness module by providing an active service based on data generated in real-time.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A system having a business aware framework for supporting situation awareness, the system comprising:
an RFID business event modeling unit for automatically generating a variety of specifications needed for developing RFID applications, through a process of modeling RFID business events and verifying information based on the modeled information, and implementing a function of loading the variety of specifications; and
the business aware framework configured between an application layer and an EPC network layer providing EPC, sensor data, and EPC reference data, for combining the EPC, the sensor data, and the EPC reference data received through the EPC network layer with business rules and situation awareness rules and generating real-time business events that can be utilized for an application based on a business event specification (BESpec).

2. The system according to claim 1, wherein the RFID business event modeling unit comprises:
an RFID business event modeling block for expressing an interface of the RFID business event in a GUI form and expressing a flow of the RFID business event;
a model information verification block for verifying possibility of creating a standard specification based on information modeled by a user in the RFID business event modeling block;
a specification automatic generation block for generating a specification based on the information modeled by the user and a conversion file;
a specification load block for analyzing the generated specification and previously generated specifications, and verifying whether information in the specifications can be expressed as modeling elements;
a model element conversion block for converting the information in the specifications analyzed in the specification load block into model elements; and
a model attribute information addition block for adding attribute information needed for a corresponding model element based on the information acquired from the specification load block.

3. The system according to claim 2, wherein the RFID business event modeling block expresses an interface of the RFID business events in a GUI form, the interface including an XML-based business event specification (BESpec) supporting an EPCglobal architecture, supporting development and management of an RFID system, and expressing the steps of acquiring and processing data in the RFID business event framework, a specification (Capture Spec) defined to store history information of REID into EPC information service (EPCIS) referenced by the BESpec, a specification (Query Spec) for querying history information related to the EPC or unique information stored in a EPCIS repository, and a specification defining an interaction with an event provider who provides real-time events.

4. The system according to claim 2, wherein the model information verification block verifies whether the specification generated based on the RFID business event model modeled by the user conforms to the BESpec and EPC Network standards and expresses a result of the verification.

5. The system according to claim 2, wherein the specification automatic generation block automatically generates an event cycle specification (ECSpec), an EPCIS capture specification (CaptureSpec) and an EPCIS query specification (QuerySpec) based on the modeled information and conversion file in conformance to the BESpec and the standards proposed by EPC Network, supports a preview function of the specifications, and stores the generated specifications.

6. A system having a business aware framework far supporting situation awareness, comprising:
the business aware framework for supporting situation awareness, including a situation awareness module having a business event specification (BESpec) that defines the steps of acquiring and processing information so as to use previously defined situation information when an application is developed based on RFID and sensor data, the situation awareness module acquiring real-time collection data and inferring currently occurred situation,
wherein the business aware framework is configured between an application layer and an EPC network layer and supports situation awareness.

7. A system having a business aware framework for supporting situation awareness, the system comprising:
an event collector (EventCollector) module for communicating with ALE and collecting information on EPC and sensor data in order to generate business events;
a service interface (ServiceInterface) module for requesting and transmitting information between the business aware framework for supporting situation awareness and a middleware user;
an external system access (ExternalSystemAccessor) module for communicating with an EPCIS, an ONS and an EPCIS DS;
a business event processor (BusinessEventProcessor) module for analyzing a business event specification (BESpec) and generating business events;
a system manager (SystemManager) module for managing the entire services, reference specifications, and setting information of the business aware framework for supporting situation awareness; and
a situation awareness (SituationReasoner) module for inferring a current situation using currently collected EPC and sensor data.

8. The system according to claim 6, wherein the BESpec is divided into a variable declaration part and an activity part, wherein the activity is divided into an initial activity for processing the step of acquiring information, a processing activity for acquiring additional information and performing comparisons and operations, and a final activity for defining the types of values resulting from conditional statements and comparison of defined situations, and the variable declaration part is used for storing processed values in the middle of processing an activity.

9. The system according to claim 8, wherein the activity part defines activities for processing and converting the values of EPC and sensor data collected in real-time, and each activity has different attribute values that need to be internally described.

10. The system according to claim 7, wherein the BESpec describes definitions of an XML format for variables, activities, and reference specifications related to a sequence and method of communicating with a variety of constitutional components of the EPC network architecture so as to allow a user to acquire information on creating business events in the business aware framework, and related to whether to generate a real-time business event by applying a business rule to the acquired information or confirm a current situation by applying a situation, awareness rule to the acquired information.

11. The system according to claim 7, wherein the EventCollector module collects real-time ALE events from ALE middleware, stores unique information on EPC through an EPCHistory class, and searches for whether a corresponding EPC has been occurred before.

12. The system according to claim 7, wherein the BusinessEventProcessor module includes variables and activity analysis classes defined in an internal BESpec, and operates neighboring modules depending on contents of an actually registered BESpec to analyze a result using types of ECSpec, ECReport, QuerySpec, and EPCIS Event as reference data types.

13. The system according to claim 7, wherein the ServiceInterface module commences or suspends a business service when the BESpec is registered or deleted, and provides an interface between a user and the business aware framework.

14. The system according to claim 7, wherein the external system access module allows an individual connection class to created in each of ONS, EPCIS, and EPCIS DS, and allows a plurality of BESpecs to access and use the created classes, so that the external system access module communicates with systems constituting an EPC network other than the ALE middleware.

15. The system according to claim 7, further comprising a repository manager (RepositoryManager) module for storing various kinds of specification information including user information, service information, and BESpec used by the business aware framework.

16. The system according to claim 7, wherein the situation awareness module acquires rule information to be compared from the SituationManager and real-time collection data through the InterfaceManager, and extracts a current situation generated if the inference engine is called through the InterfaceManager.

17. The system according to claim 7, wherein an internal inference process of the SituationReasoner module comprises the steps of:
processing sensed data and command in real-time through an interface engine;
collecting and processing fact values through the SituationManager; and
extracting information based on facts and rule matching, and analyzing and providing real-time information.

18. The system according to claim 17, wherein the step of processing sensed data and command in real-time comprises the steps of:
processing the sensed data and command in real-time;
analyzing the command and transmitting a result of the analysis; and
transmitting information on the sensed data and updating the facts after inferring and filtering meaningful data.

19. The system according to claim 17, wherein the step of collecting and processing fact values comprises the steps of:
re-collecting facts periodically or depending on a change of sensor values;
collecting values of an N-triple (subject, predicate and object) form for modeling; and
storing, managing, and updating the fact values.

20. The system according to claim 17, wherein the step of extracting information based on facts and rule matching comprises the steps of:
collecting and managing external input values;
storing and managing policy of rules, and extracting information based on the facts and rule matching;
re-inferring the extracted values and processing information;
organizing and managing result values;
transmitting the information to a service manager in a predefined format; and
analyzing and transmitting a query for real-time information management and service provision.

21. The system according to claim 7 wherein in an internal inference process of the SituationReasoner module, if information or a command is inputted while an inference engine is waiting in a sleep or listening state, the inference engine transits to a wakeup state, analyzes the input value, and transmits the input value to a state part of ‘command’, ‘sensed data’, ‘query’ depending on the type of the input value.

22. The system according to claim 21, wherein the ‘command’ is a part for implementing an operation of a specific device or a statically patterned service depending on a user's command,
the ‘sensed data’ is a part for implementing an operation of an additional service caused by a change of external environments or an operation for dynamically monitoring a change in the external environments, and
the ‘query’ is a part for processing information created and inputted through an external query API when a user requests to search for a location, a device state, or environment information.
